(19) United States
(12) Patent Application Publication
(10) Pub. No.: US 2024/0272874 A1
(43) Pub. Date: Aug. 15, 2024

(54) SYSTEM AND METHOD FOR OPTIMIZED PROCESSING OF REQUIREMENTS DATA IN A SOFTWARE DEVELOPMENT LIFE CYCLE

(71) Applicant: Cognizant Technology Solutions India Pvt. Ltd., Chennai (IN)

(72) Inventors: Dattaprasad Kulkarni, Pune (IN); Hemant Patil, Pune (IN); Rajeswari Kumaran, Chennai (IN); Neya Renganathan, Coimbatore (IN); Radha Ponram, Coimbatore (IN); Komal Sinha, Patna (IN)

(21) Appl. No.: 18/136,930

(22) Filed: Apr. 20, 2023

(30) Foreign Application Priority Data
Feb. 10, 2023 (IN) 202341008653

(51) Int. Cl. G06F 8/10; G06F 40/295

(52) U.S. Cl. CPC G06F 8/10; G06F 40/295

(57) ABSTRACT

A system and method for optimized processing of requirements data in a software development life cycle is provided. The present invention provides for determining a first pre-defined parameter, a second pre-defined parameter, a third pre-defined parameter, a fourth pre-defined parameter, a fifth pre-defined parameter, a sixth pre-defined parameter, and a seventh pre-defined parameter associated with user story by applying pre-defined rules respectively. Further, an output is rendered as Requirement Completeness Index (RCI) for user story data, and corrective actions are automatically carried out on user story data based on the generated RCI.

### FIELD OF THE INVENTION

The present invention relates generally to the field of data processing, and more particularly, to a system and a method for optimized processing of user requirements data in a software development life cycle.

### BACKGROUND OF THE INVENTION

In a Software Development Life Cycle (SDLC), accurate processing of user requirements data in a requirement phase is essential for determining quality of the application (or product) being developed. User requirements in SDLC relate to the user's (i.e., client) needs and necessities expected out of the developed application. The requirements are generally provided by the user in natural language and are distinct for different domains. It has been observed that user requirements provided in natural language are vague and are usually associated with certain defects and ambiguities, that may affect quality of the developed application. It has been further observed that the user requirements data may be associated with insufficient documentation, which may lead to data changes during application execution. Insufficient documentation of user requirements data may cause delays in scheduled delivery of the developed applications along with application release schedule slippages. As such, development of applications becomes expensive and application maintenance cost also increase.

Typically, insufficient documentation of user requirements data may impact knowledge transfer process of the application, in the event employee associated with the development of the application leaves the organization. In a scenario in which users and application development team may not be connected via a face-to-face communication on daily basis, the user requirements data may be associated with inadequate details which may cause loss of domain/application knowledge and pose challenges to accurately process the data. Furthermore, identification of defects and ambiguities in data associated with user requirements data is generally carried out manually, which is not consistent and is error prone. Yet further, if the defects and ambiguities data associated with the documentation of the user requirements data are not identified and resolved adequately, then there is a risk of processing incomplete user requirements, thereby leading to poor quality of developed applications.

In light of the aforementioned drawbacks, there is a need for a system and a method which provides for optimized processing user requirements data in a software development life cycle in an efficient manner. Further, there is a need for a system and a method which provides for adequately and determining and consistently defects ambiguities associated with user requirements data. Further, there is a need for a system and a method which provides for reduced processing time of the user requirements data, and less memory usage for processing the user requirements data.

### SUMMARY OF THE INVENTION

In various embodiments of the present invention, a system for optimized processing of requirements data in a software development life cycle is provided. The system comprises a memory storing program instructions; a processor executing instructions stored in the memory; and a requirements analysis engine executed by the processor. The requirements analysis engine is configured to process fetched user story data from a database for determining a first pre-defined parameter associated with the user story by applying a first set of pre-defined rules. The first pre-defined parameter represents persona of the user associated with the user story data. Further, the requirements analysis engine is configured to determine a second pre-defined parameter associated with the user story data by applying a second set of pre-defined rules. The second pre-defined parameter represents action requirement associated with the user story data for an application. Further, the requirements analysis engine is configured to determine a third pre-defined parameter associated with the user story data by applying a third set of pre-defined rules. The third pre-defined parameter represents action outcome associated with the user story data for the application. Further, the requirements analysis engine is configured to determine a fourth pre-defined parameter associated with the user story data by applying a fourth set of pre-defined rules. The fourth pre-defined parameter represents atomicity of the user story data. Further, the requirements analysis engine is configured to determine a fifth pre-defined parameter associated with the user story data by applying a fifth set of pre-defined rules. The fifth pre-defined parameter represents ambiguity in the user story data. Further, the requirements analysis engine is configured to determine a sixth pre-defined parameter associated with the user story data by applying a sixth set of pre-defined rules. The sixth pre-defined parameter represents acceptance criteria for the user story data. Lastly, the requirements analysis engine is configured to determine a seventh pre-defined parameter associated with the user story data by applying a seventh set of pre-defined rules. The seventh pre-defined parameter represents determination of length of the user story data. Further, the system comprises an output and correction unit configured to render an output in the form of a Requirement Completeness Index (RCI) for the user story data. The RCI is generated based on a cumulative computation of percentage weighted score for each of the pre-defined parameters, and corrective actions are carried out automatically on the user story data based on the generated RCI.

In various embodiments of the present invention, a method for optimized processing of requirements data in a software development life cycle is provided. The method is implemented by a processor executing instructions stored in a memory. The method comprises processing fetched user story data from a database for determining a first pre-defined parameter associated with the user story by applying a first set of pre-defined rules. The first pre-defined parameter represents persona of the user associated with the user story data. Further, the method comprises determining a second pre-defined parameter associated with the user story data by applying a second set of pre-defined rules. The second pre-defined parameter represents action requirement associated with the user story data for an application. Further, the method comprises determining a third pre-defined parameter associated with the user story data by applying a third set of pre-defined rules. The third pre-defined parameter represents action outcome associated with the user story data for the application. Further, the method comprises determining a fourth pre-defined parameter associated with the user story data by applying a fourth set of pre-defined rules. The fourth pre-defined parameter represents atomicity of the user story data. Further, the method comprises determining a fifth pre-defined parameter associated with the user story data by applying a fifth set of pre-defined rules. The fifth pre-defined parameter represents ambiguity in the user story data. Further, the method comprises determining a sixth pre-defined parameter associated with the user story data by applying a sixth set of pre-defined rules. The sixth pre-defined parameter represents acceptance criteria for the user story data. Further, the method comprises determining a seventh pre-defined parameter associated with the user story data by applying a seventh set of pre-defined rules. The seventh pre-defined parameter represents determination of length of the user story data. Lastly, the method comprises rendering an output in the form of a Requirement Completeness Index (RCI) for the user story data. The RCI is generated based on a cumulative computation of percentage weighted score for each of the pre-defined parameters, and corrective actions are automatically carried out on the user story data based on the generated RCI.

In various embodiments of the present invention, a computer program product comprising a non-transitory computer-readable medium having computer program code stored thereon is provided. The computer-readable program code comprises instructions that, when executed by a processor, causes the processor to process fetched user story data for determining a first pre-defined parameter associated with the user story by applying a first set of pre-defined rules. The first pre-defined parameter represents persona of the user associated with the user story data. Further, a second pre-defined parameter associated with the user story data is determined by applying a second set of pre-defined rules. The second pre-defined parameter represents action requirement associated with the user story data for an application. Further, a third pre-defined parameter associated with the user story data is determined by applying a third set of pre-defined rules. The third pre-defined parameter represents action outcome associated with the user story data for the application. Further, a fourth pre-defined parameter associated with the user story data is determined by applying a fourth set of pre-defined rules. The fourth pre-defined parameter represents atomicity of the user story data. Further, a fifth pre-defined parameter associated with the user story data is determined by applying a fifth set of pre-defined rules. The fifth pre-defined parameter represents ambiguity in the user story data. Further, a sixth pre-defined parameter associated with the user story data is determined by applying a sixth set of pre-defined rules. The sixth pre-defined parameter represents acceptance criteria for the user story data. Further, a seventh pre-defined parameter associated with the user story data is determined by applying a seventh set of pre-defined rules. The seventh pre-defined parameter represents determination of length of the user story data. Lastly, an output is rendered in the form of a Requirement Completeness Index (RCI) for the user story data. The RCI is generated based on a cumulative computation of percentage weighted score for each of the pre-defined parameters, and corrective actions are automatically carried out on the user story data based on the generated RCI.

### BRIEF DESCRIPTION OF THE ACCOMPANYING DRAWINGS

The present invention is described by way of embodiments illustrated in the accompanying drawings wherein:

FIG. 1 is a detailed block diagram of a system for optimized processing of user requirements data in a software development life cycle, in accordance with an embodiment of the present invention;

FIG. 2 illustrates determining a first pre-defined parameter associated with a user story data, in accordance with an embodiment of the present invention;

FIG. 3 illustrates determining a second pre-defined parameter associated with the user story data, in accordance with an embodiment of the present invention;

FIG. 4 illustrates determining the second pre-defined parameter associated with the user story data, in accordance with another embodiment of the present invention;

FIG. 5 illustrates determining a third pre-defined parameter associated with the user story data, in accordance with an embodiment of the present invention;

FIG. 6 illustrates determining the third pre-defined parameter associated with the user story data, in the event user story format is not determinable, in accordance with an embodiment of the present invention;

FIG. 7 illustrates determining a fourth pre-defined parameter associated with the user story data, in accordance with an embodiment of the present invention;

FIG. 8 illustrates determining the fourth pre-defined parameter associated with the user story data despite presence of a conjunction, in accordance with an embodiment of the present invention;

FIG. 9 illustrates determining fifth pre-defined parameter associated with the user story data, in accordance with an embodiment of the present invention;

FIG. 10 illustrates a flowchart depicting clustering of user stories data and acceptance criteria associated with historical user story data, in accordance with an embodiment of the present invention;

FIGS. 11 and 11A illustrate a flowchart depicting a method for optimized processing of user requirements data in a software development life cycle, in accordance with an embodiment of the present invention; and

FIG. 12 illustrates an exemplary computer system in which various embodiments of the present invention may be implemented.

### DETAILED DESCRIPTION OF THE INVENTION

The present invention discloses a system and a method which provides for optimized processing of user requirements data in a software development life cycle. The present invention discloses a system and a method which provides for adequately and consistently determining defects and ambiguities associated with the user requirements data. The present invention provides for effective Natural Language Processing (NLP) of input data for efficiently and accurately developing applications. Further, the present invention discloses a system and a method which provides for preventing loss of data associated with user requirements for appropriate maintenance of applications and knowledge transfer processes associated with the applications. Further, the present invention discloses a system and a method which provides for reduced processing time of the user requirements data, and less memory usage for processing the user requirements data. Furthermore, the present invention discloses a system and a method which provides for timely delivery of developed applications without any schedule slippages and in a cost-effective manner based on appropriate determination of defects and ambiguities associated with the user requirements.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

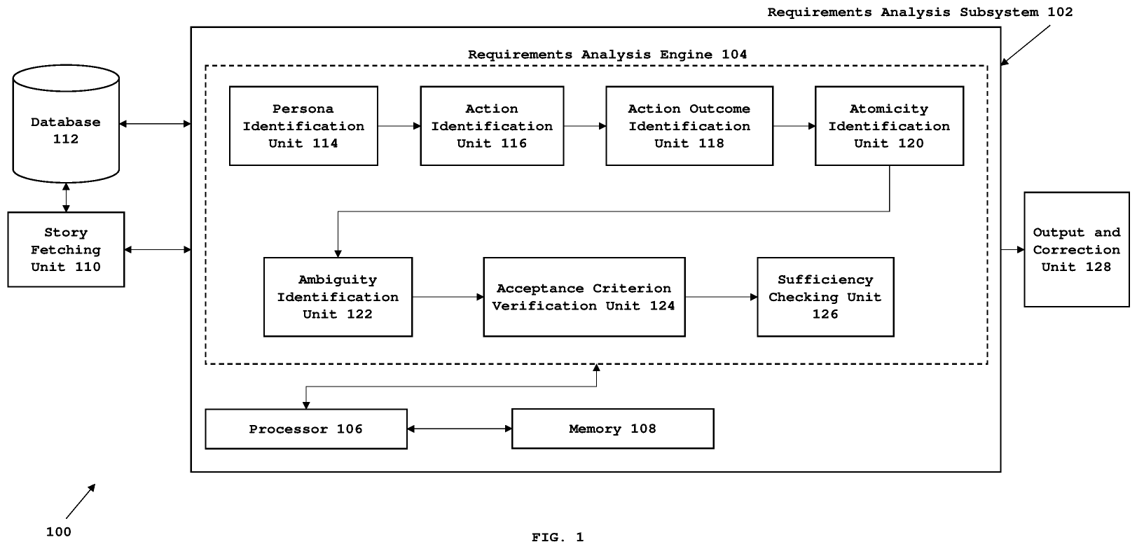

FIG. 1 is a detailed block diagram of a system 100 for optimized processing of user requirements data in a software development life cycle, in accordance with various embodiments of the present invention. Referring to FIG. 1, in an embodiment of the present invention, the system 100 comprises a requirements analysis subsystem 102 (subsystem 102), a story fetching unit 110, a database 112, and an output and correction unit 128. The user story fetching unit 110, the database 112, and the output and correction unit 128 are connected to the subsystem 102 via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a local area network (LAN), a metropolitan area network (MAN) and a wide area network (WAN). In an embodiment of the present invention, the database 112 may be installed locally at the organization's end or at a remote location.

In an embodiment of the present invention, the subsystem 102 is configured with a built-in-intelligent mechanism for optimized processing of user requirements data in a software development life cycle. The subsystem 102 is configured to fetch user requirements data from Application Life Management (ALM) tools. The subsystem 102 is configured to pre-process the user requirements data to identify acceptance criteria associated with the user requirements data and split the acceptance criteria in a separate field for verification. The pre-processing step cleanses the user requirements data. The user requirements data is fetched by the subsystem 102 in an incremental manner so that the modified and newly created user requirements data are fetched from ALM tools. In an embodiment of the present invention, the subsystem 102 is configured to determine defects and ambiguities present in the user requirements data by processing and parsing natural language (NL) data associated with the user requirements data. The subsystem 102 is configured to provide insights with respect to the determined defects and ambiguities data associated with the user requirements data such that a suitable action may be executed for correcting the user requirements data. In an embodiment of the present invention, the subsystem 102 is configured to check presence and validity of one or more pre-defined parameters associated with the user requirements based on execution of one or more pre-defined rules, and provide a comprehensive score associated with correctness and completeness of user requirements, as elaborated later in the specification. In an exemplary embodiment of the present invention, the pre-defined rules are generated based on inputs received from agile requirement developers.

In another embodiment of the present invention, the subsystem 102 may be implemented in a cloud computing architecture in which data, applications, services, and other resources are stored and delivered through shared datacenters. In an exemplary embodiment of the present invention, the functionalities of the subsystem 102 are delivered to a user as Software as a Service (Saas) or a Platform as a Service (PaaS) over a communication network.

In yet another embodiment of the present invention, the subsystem 102 may be implemented as a client-server architecture. In this embodiment of the present invention, a client terminal accesses a server hosting the subsystem 102 over a communication network. The client terminals may include but are not limited to a computer, a tablet, or any other wired or wireless terminal. The server may be a centralized or a decentralized server.

In an embodiment of the present invention, the subsystem 102 comprises a requirements analysis engine 104 (engine 104), a processor 106 and a memory 108. In various embodiments of the present invention, the engine 104 has multiple units, which work in conjunction with each other for optimized processing of user requirements data in a software development life cycle. The various units of the engine 104 are operated via the processor 106 specifically programmed to execute instructions stored in the memory 108 for executing respective functionalities of the units of the engine 104 in accordance with various embodiments of the present invention.

In an embodiment of the present invention, the engine 104 comprises a persona identification unit 114, an action identification unit 116, an action outcome identification unit 118, an atomicity identification unit 120, an ambiguity identification unit 122, an acceptance criterion verification unit 124, and a sufficiency checking unit 126.

In an embodiment of the present invention, user requirements are present in the form of user stories data at an external source system (not shown) installed at the user-end. The user story data is generally in the form of NL. User stories data aid in determining how a software development work may deliver value to the user. The user stories data are provided as primary input for creating application increments. Application increments relate to developments carried out in a specified time on an existing application. In operation, in an embodiment of the present invention, the story fetching unit 110 is configured to periodically and incrementally fetch user stories data from the external source systems by using workflow management tools such as Jira®, etc. The fetched user stories data are stored in the database 112 for later retrieval.

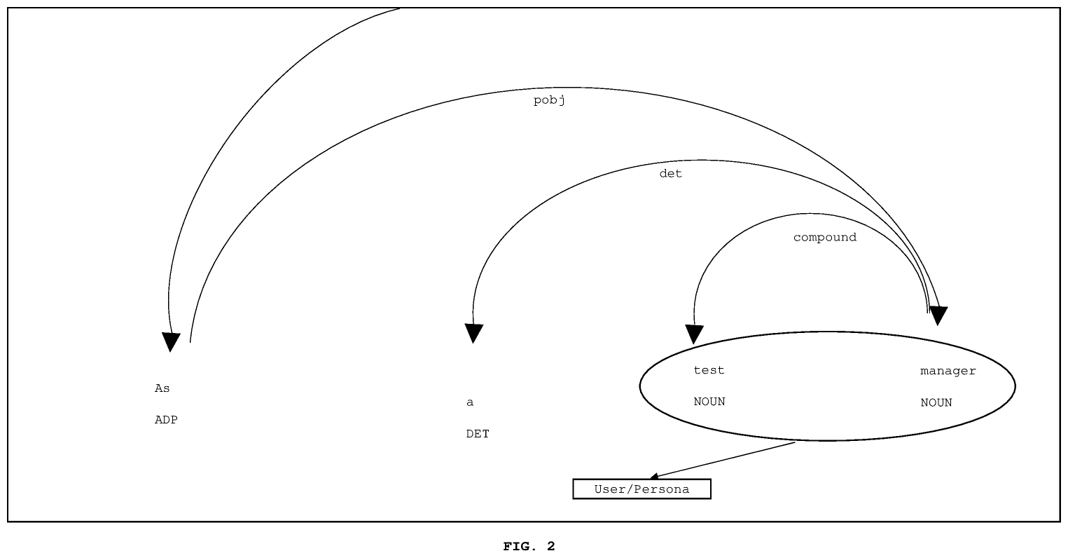

In an embodiment of the present invention, the story fetching unit 110 is configured to communicate with the database 112 for retrieving the stored story data and transmit the retrieved data to story the persona identification unit 114. The persona identification unit 114 is configured to determine a first pre-defined parameter associated with the user story data by processing NL data present in the user story data by applying a first set of pre-defined rules. In an exemplary embodiment of the present invention, the first pre-defined parameter represents the persona of the user associated with the user story data. In an exemplary embodiment of the present invention, the persona identification unit 114 is configured to determine user persona from the user story data in two ways by applying the first set of pre-defined rules. Firstly, the persona identification unit 114 processes a user story data format used for user story creation. The user story data format is processed by analyzing one or more regular expressions present in the user story to determine and validate the user persona associated with the user story data. The persona identification unit 114 analyzes the regular expressions by applying a pre-built NLP library, stored in the database 112. The pre-built NLP library is built based on historical data associated with various user stories of different domains. The persona identification unit 114 determines regular expression data present in the user story as Parts of Speech (POS) (e.g., nouns, verbs, ADP (adposition), DET (determiner), etc.), and further determines correlation between the data present in the user story data. For example, if the user story data format is described as “as a test manager I should be able to delete all defects that are stale so that defect backlog is optimized”, a regular expression, “r′(?:\bAs\b|\.\s+?\bAs\b|\n\s?\bAs\b)\s+(\w+)\s+(\w+)(?:\s+\w+)?(?:\s+\w+)′” is used to identify the noun or proper noun further determine correlation between the data present in the user story data. In another example, if user story data is described as ‘as a test manager I should be able to delete all defects that are stale so that defect backlog is optimized’, then user persona determined is ‘test manager’, as illustrated in FIG. 2. The data ‘test’ and ‘manager’ are identified as nouns, the data ‘as’ is identified as ADP and the data ‘a’ is identified as DET. Secondly, in the event, it is determined by the persona identification unit 114 that the user story format is not determinable from the user story data, then NLP Parts-Of-Speech (POS) parsers are applied by the persona identification unit 114 to identify POS from the user story data, such as, first proper noun that is present in the user story sentence for identifying the user persona. Further, identified user persona from the user story data is verified against a Named Entity Recognition (NER) dataset created based on the format of user story data, and if verified successfully POS is identified as user persona. For example, if the user story is described as ‘administrator should be able to configure user role-based access’ then the user persona determined is ‘administrator’, as POS tag identifies ‘administrator’ as proper noun. The identified user persona is then verified against NER dataset and is identified as a valid user persona.

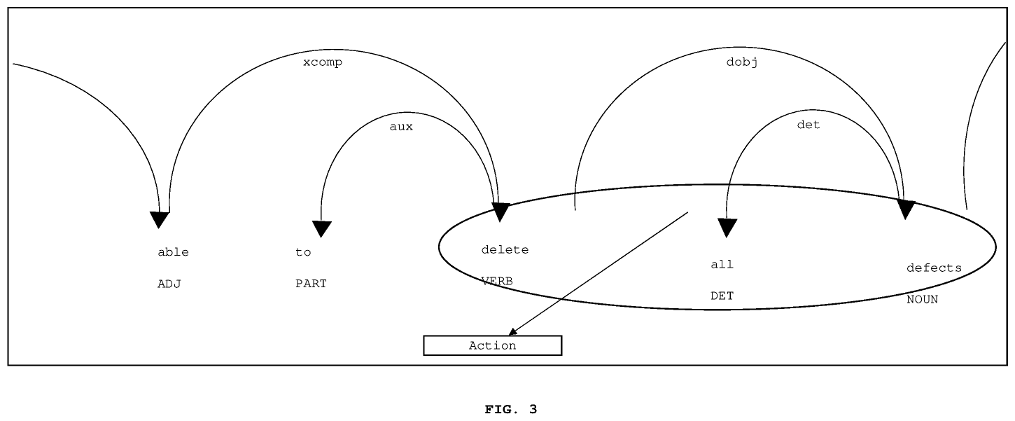

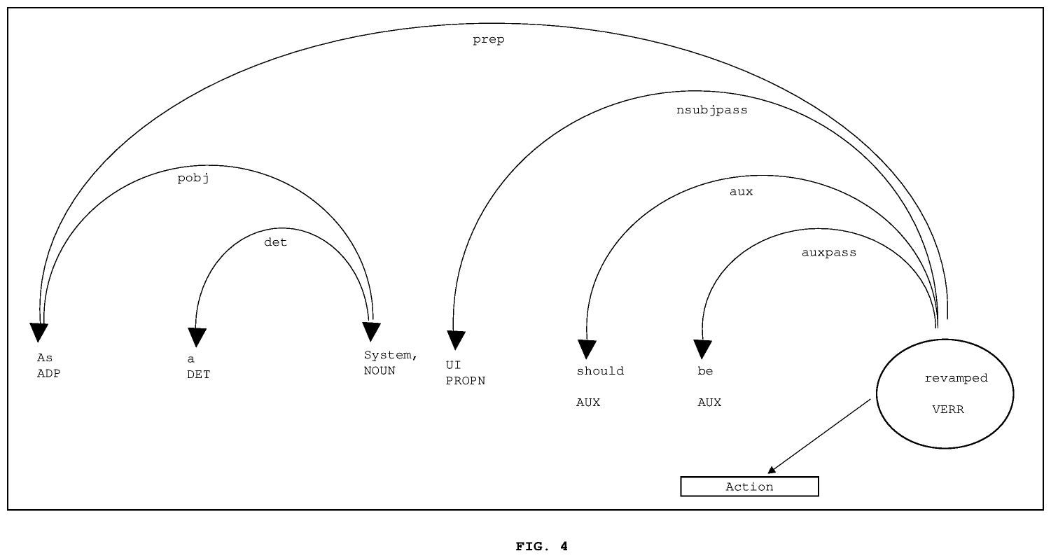

In an embodiment of the present invention, the action identification unit 116 is configured to receive the user story data from the persona identification unit 114 and determine a second pre-defined parameter associated with the user story data. The second pre-defined parameter is determined by applying a second set of pre-defined rules. In an exemplary embodiment of the present invention, the second pre-defined parameter represents action requirement associated with the user story data for an application. The action identification unit 116 is configured to analyze the user story data for extracting the action requirement by applying the second set of pre-defined rules. The action identification unit 116 is configured to determine a data pattern in the user story data in the event user story format is determinable for determining the second pre-defined parameter. As such, a regular expression “r′(?:\bI want \b|\bwant\b|\bI should\b|\bwe want\b|\bwe should\b|\bI′m able to\b|\bI'm able to\b|\bI am able to\b|\bI wish to\b|\bI can\b|\bI would like to\b|\bI need to\b|\bshould be able to\b|\bI could\b|\bcan able to\b|\bcould be\b|\bable to\b|\need\b|\bneeds\b|\bshould find\b|\bmust be\b|\bI do\b|\bto see\b)*” is applied to determine the verb following this pattern or regex pattern “r′.+(?=\bso that\b|\bso as to\b|\bIn order to\b|\bBecause of \b|\bSo\b|\bsuch that\b)′” is applied to determine the verb appearing before this pattern. For example, if the user story data is described as ‘as a test manager I should be able to delete all defects that are stale so that defect backlog is optimized’, then the first regex pattern is applied to determine the verb following this pattern or regex pattern and the action requirement determined is ‘delete all defects’, as illustrated in FIG. 3. In another embodiment of the present invention, in the event user story format is not determinable, then the action identification unit 116 is configured to determine the second pre-defined parameter by firstly, determining a first POS (such as verbs) using one or more NLP POS tags (e.g., POBJ, DOBJ, XCOMP (Open Clausal Complement), etc.); secondly, determining root of the first word with POS (‘VB’ (verb), ‘VBG’ (verb gerund), ‘VBZ’ (verb, present tense with third person singular), ‘VBD’ (verb past tense)) is a PREP (preposition) having dependency tag XCOMP and child of the verb having a dependency tag DOBJ (Direct Object); and thirdly, if there is no root associated with XCOMP, and if child of the first word with POS (‘VB’, ‘VBG’, ‘VBZ’, ‘VBD’) is a PREP (preposition), then child of PREP is checked. In an example, if a user story data is described as ‘as a system, User Interface (UI) should be revamped’, then the action requirement is identified based on root of action word “revamped” (which is the verb identified with the POS tags) with associated POBJ (Object of Preposition) which is “system”, as illustrated in FIG. 4. As such, the dependency tag between the PREP word and its child may be POBJ or DOBJ.

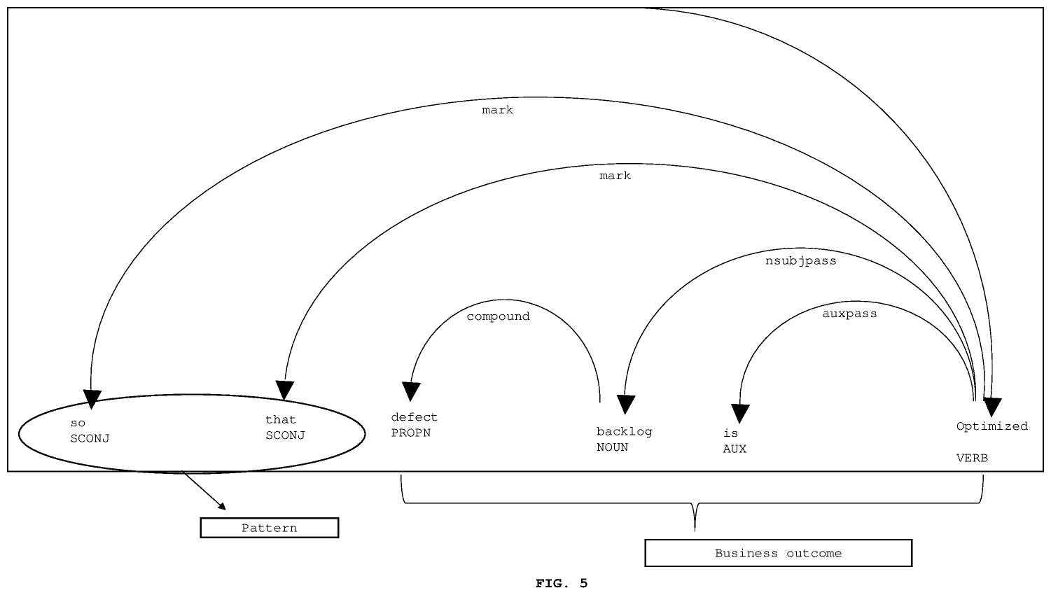

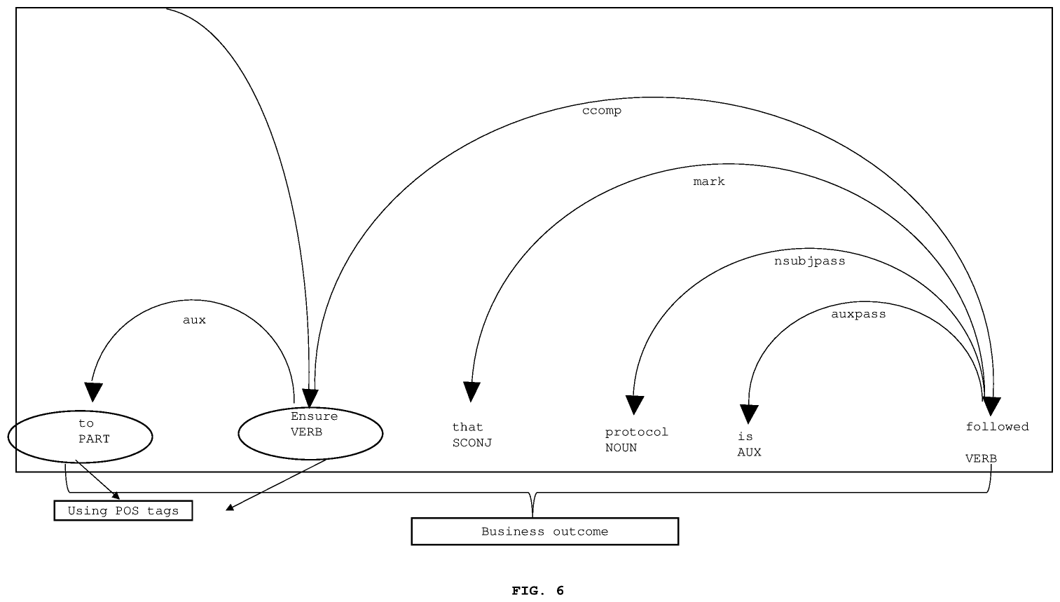

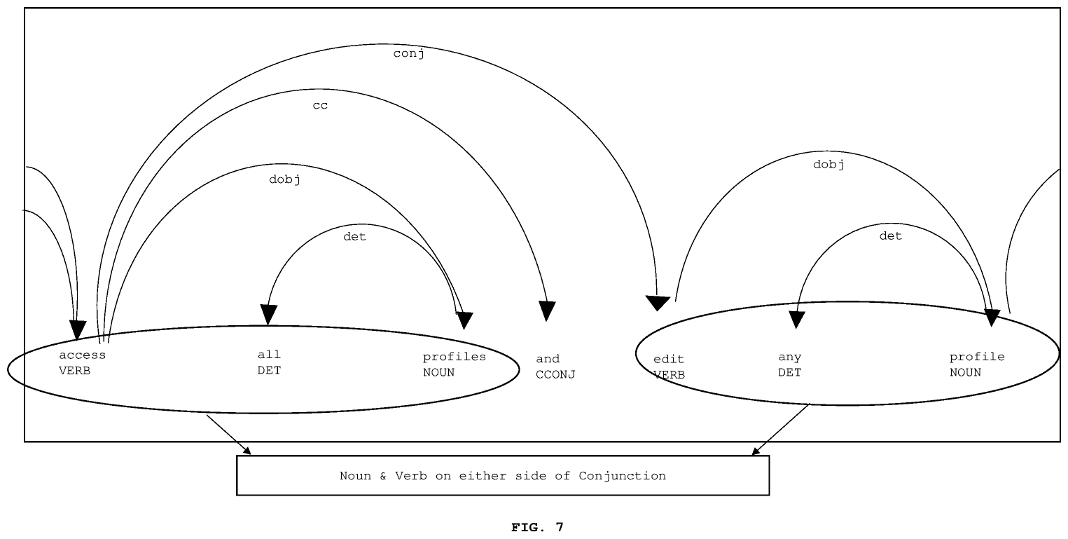

In an embodiment of the present invention, the action outcome identification unit 118 is configured to receive the user story data from the action identification unit 116. In an embodiment of the present invention, the action identification unit 116 is configured to determine a third pre-defined parameter associated with the user story data, subsequent to action identification, by applying a third set of pre-defined rules. In an exemplary embodiment of the present invention, the third pre-defined parameter represents action outcome associated with the user story data for an application. The action outcome identification unit 118 is configured to analyze the user story data for extracting the action outcome requirement from the user story data by applying the third set of pre-defined rules. In an embodiment of the present invention, in the event user story format is determinable, then the action outcome identification unit 118 is configured to determine the third pre-defined parameter by applying the Regex (regular expressions) data. In an exemplary embodiment of the present invention, Regex “(?: \bso that\b|\bso as to\b|\bIn order to\b|\bBecause\b|\bSo\b|\bthus\b).*′” is applied to determine the action outcome that comes after the pattern. For example, if the user story data is described as ‘as a test manager I should be able to delete all defects that are stale so that defect backlog is optimized’, then the data pattern determined in the user story relates to ‘so that’ and the action outcome determined is ‘defect backlog is optimized’, as illustrated in FIG. 5. In another embodiment of the present invention, in the event user story format is not determinable, then the action outcome identification unit 118 is configured to determine the third pre-defined parameter based on using POS tags. In this scenario, a phrase occurring in the last part of the user story data is identified by words following action. In this last part, phrase starting with ‘to’ which follows a verb (using POS tags ‘VB’, ‘VBG’, ‘VBZ’, ‘VBD’) other than ‘be’ is determined as the action outcome. For example, if the user story data is described as ‘as an admin, I should have access to all profiles to ensure that protocol is followed’, then the POS tags (‘VB’, ‘VBG’, ‘VBZ’, ‘VBD’) are used to determine the action outcome requirement associated with the user story data, which is ‘to ensure that protocol is followed’, as illustrated in FIG. 6.

In an embodiment of the present invention, the action identification unit 116 is configured to minimize false positive data. The action identification unit 116 is configured to identify POS tags specific to context of the user story data. For example, the data ‘link’ may be a verb or noun depending on the context of the user story data. In an exemplary embodiment of the present invention, the action outcome identification unit 118 is configured to execute a data model by using a Viterbi® technique in order to minimize false positive data. As such, the data model is trained with a static list of words tagged to the POS so that appropriate parts of speech can be identified based on the current context of the user story data. Appropriate parts of speech are identified based on custom training of the data model using Viterbi® technique. The Viterbi® technique works on the basis of Hidden Markov Model and is optimized for better memory usage to determine the false positive data.

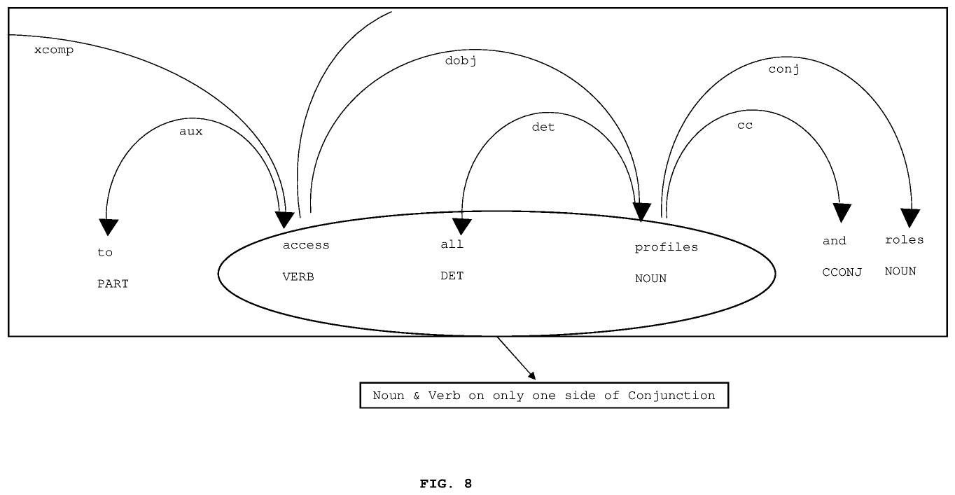

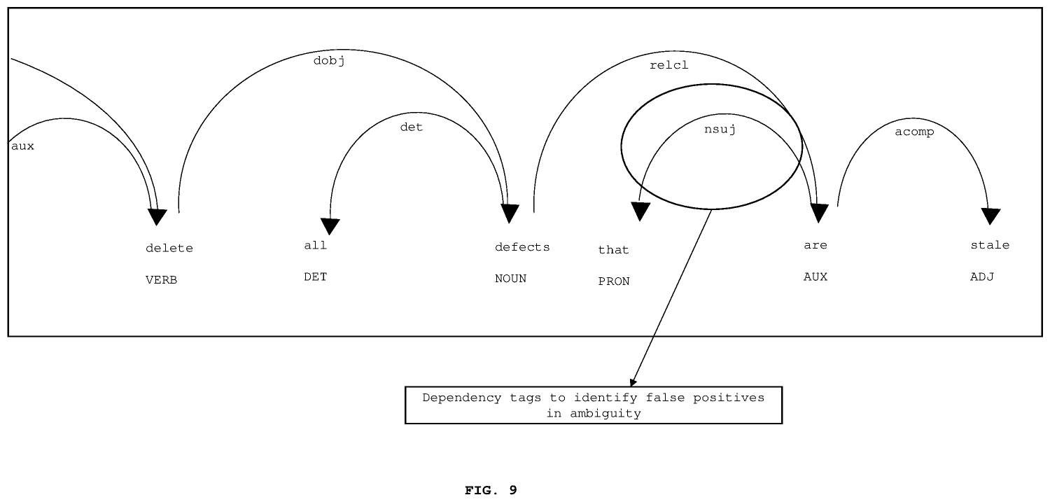

In an embodiment of the present invention, the atomicity identification unit 120 is configured to receive the user story data from the action outcome identification unit 118 for determining a fourth pre-defined parameter associated with the user story data by applying a fourth set of pre-defined rules. In an exemplary embodiment of the present invention, the fourth pre-defined parameter represents atomicity of the user story data. The atomicity identification unit 120 is configured to determine atomicity of the user story data by analyzing the action identified by the action identification unit 116 for identifying the POS having one or more actions (‘VB’, ‘VBG’, ‘VBZ’, ‘VBD’) based on executing the fourth set of pre-defined rules. The fourth set of pre-defined rules are executed based on the POS tag of CONJ (conjunction). For example, in the event there are multiple POS identified as conjunction, then in such POS a check is carried out for determining a noun with a corresponding verb, as illustrated in FIG. 7. As such, if a verb is not associated with the noun, then the user story data is determined to have atomicity. In another example, atomicity in the user story data may be identified by the atomicity identification unit 120, despite presence of a conjunction, as illustrated in FIG. 8.

In an embodiment of the present invention, the ambiguity identification unit 122 is configured to analyze the user story data for determining a fifth pre-defined parameter associated with the user story data by applying a fifth set of pre-defined rules. In an exemplary embodiment of the present invention, the fifth pre-defined parameter represents ambiguity in the user story data. The ambiguity identification unit 122 is configured to determine one or more categories associated with the ambiguous words by applying the fifth set of pre-defined rules. The categories associated with ambiguous words include, but are not limited to, comparative data, indirect data, persuasion data, qualifier data, and quantities data. The categories of ambiguous words are determined by checking for the presence of ambiguous words from a pre-defined dataset of ambiguous words present in the user story data. In an example, the comparative data includes phrases comparing two or more data types, and determining object of the data being compared (e.g., bigger, smaller, wider, biggest, smallest, etc.). The indirect data include data that suggest possibility of a user requirement happening (e.g., should, could, may and will), but not specifically determining when and how the user requirement may happen. The persuasion data includes data which is obvious and based on an opinion or a fact (e.g., clearly, certainly, and obviously). The qualifier data includes data used to modify existing data for determining correct inference (e.g., all, every, none, only, never, always, sometimes, often, usually, etc.). The quantities data include data defining some amount, number, or items (e.g., a, an, some, most, few, etc.). In another embodiment of the present invention, the ambiguity identification unit 122 is configured to identify the false positive data associated with the identified ambiguities data present in the user story data for correctly determining the ambiguity data. For example, the data ‘all’ is a word indicating ambiguity and if the entity denoted by ‘all’ is qualified sufficiently, then there is no ambiguity. Further, in order to determine whether there is a qualifier data, the dependency modifier tags e.g., “relcl” (relative clause), “acl” (adnominal clause?), “advmod” (adverbial modifier), “advmod: emph” (emphasizing word of adverbial modifier) and “amod” (adjectival modifier) are used. If the dependency modifier tags are used along with the entity in the user story data, then the dependency modifier tags are not marked as ambiguous by the ambiguity determination unit 122 if ambiguous words are present in the user story data. Further, the dependency modifier tag is used to mark ‘all defects that are stale’ as unambiguous even though the ambiguous word “all” is present, as illustrated in FIG. 9.

In an embodiment of the present invention, the acceptance criteria verification unit 124 is configured to receive the analyzed user story data from the ambiguity identification unit 122 for determining a sixth pre-defined parameter associated with the user story data by applying a sixth set of pre-defined rules. In an exemplary embodiment of the present invention, the sixth pre-defined parameter represents acceptance criteria for the user story data. As such, the acceptance criteria may or may not be a part of the user story data. For example, if a user story data is defined as “as a scrum master I would like to view all past unresolved defects so that I can create a defect board”, then an acceptance criterion is “unresolved defects should be one of the following status—new, active, and deferred”, “defects with notes on dependency should be flagged for attention” and “defects should be listed in reverse chronological order along with module information. The acceptance criteria are determined by implementing, by the acceptance criteria verification unit 124, a trained acceptance criteria ML model, stored in the database 112, using the sixth set of pre-defined rules. The acceptance criteria ML model is trained and generated based on historical acceptance criteria data. In an exemplary embodiment of the present invention, the acceptance criteria ML model determines the acceptance criteria by determining if the acceptance criteria data has been added in the user story data description field. The acceptance criteria are determined by analyzing one or more suffix tags such as ‘acceptance criteria:’, ‘acc. criteria:’, etc., present in the user story data. The suffix tags are identified by one or more data input adaptors associated with the acceptance criterion ML model. The identified suffix data is thereafter stored in a separate data field in the database 112. In another embodiment of the present invention, one or more data adaptors are created for the specific Application Life Management (ALM) tool using the relevant APIs to retrieve user story data. Once the user story data is retrieved in the data adaptor, it checks for data related to acceptance criteria based on the default list of tags used to identify acceptance criteria. The data adaptor further determines a parameter if the tags are not one of the tags available in the pre-defined tags. The parameter is then stored and used for subsequent incremental data processing. Further, the acceptance criteria are determined by the acceptance criteria ML model based on associated historical data of user story data and corresponding acceptance criteria by carrying out pattern mining to identify the association amongst user story data. For example, if a user story data is described as, ‘add a user’, then the acceptance criteria associated with the said user story data may be determined as ‘add user in bulk’, ‘add one user at a time’ or ‘what type of user needs to be added’.

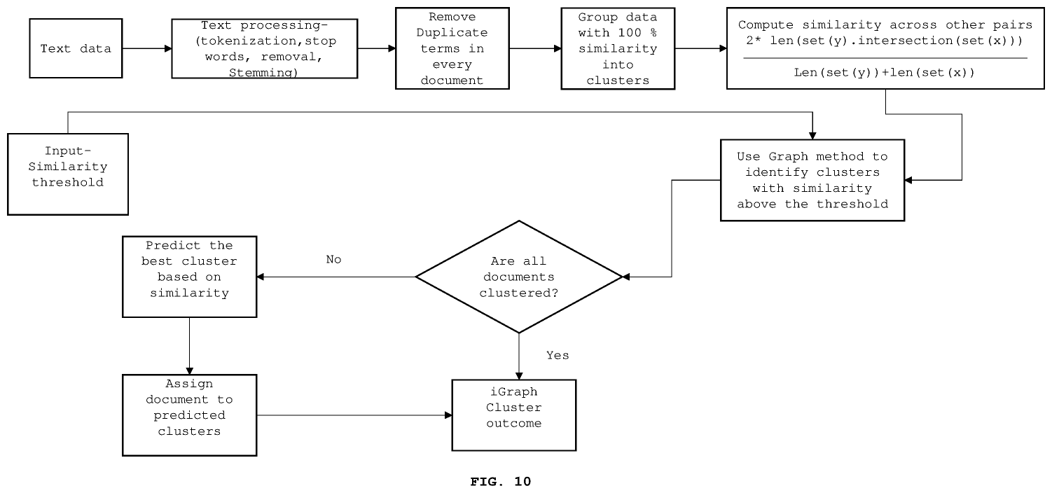

In an embodiment of the present invention, the acceptance criteria may be determined by the acceptance criteria ML model for new user stories data by carrying out nested clustering of user stories data and acceptance criteria associated with the historical user story data. In an exemplary embodiment of the present invention, a custom iGraph clustering technique is implemented by the acceptance criteria verification unit (124) to carry out clustering of user stories data and acceptance criteria associated with the historical user story data. Further, based on the clustering technique, repeatable acceptance criteria appearing under different, but similar, user stories data are identified. The user stories data are created as a pattern and stored in the database 112. When a new user story is processed, it is validated for similarity with the stored pattern and the corresponding acceptance criteria is recommended by the acceptance criteria verification unit 124. Clustering of user stories data and acceptance criteria associated with the historical user story data using iGraph clustering technique has been illustrated in FIG. 10. Advantageously the iGraph clustering technique aids in overcoming issues related to bad clusters which are typically provided by KMeans and hierarchical clustering. Further, iGraph clustering technique also provides flexibility to the application developer to select required similarity suitably.

In an embodiment of the present invention, the sufficiency checking unit 126 is configured to receive the user story data from the acceptance criteria verification unit 124 for determining a seventh pre-defined parameter associated with the user story data by applying a seventh set of pre-defined rules. In an exemplary embodiment of the present invention, the seventh pre-defined parameter represents determination of length of the user story data. In an embodiment of the present invention, the sufficiency checking unit 126 is configured to verify whether the length of the user story data is greater than a pre-defined user story data configurable length or not. In an exemplary embodiment of the present invention, the count of words in the user story data before eliminating the stop words is computed as length of the user story data. Determination of length of the user story data determines if sufficient data is provided in the user story data. The sufficiency checking unit 126 is configured to flag the user stories data having data less than the pre-defined user story data configurable length. For example, user story data defined as ‘software upgrade’ is flagged as having data less than the pre-defined user story data configurable length. In another embodiment of the present invention, the sufficiency checking unit 126 is configured to determine that each user story data is unique based on verification of the title or summary of the user story data. The title or summary of the user story data is verified to be unique based on comparison with the other user stories delivered in the current or past sprints. The comparison is done by carrying out a string match between the titles of user stories data by the sufficiency checking unit 126.

In an embodiment of the present invention, subsequent to the processing of the user story data by various units of the engine 104, an output is rendered at the user-end via the output and correction unit 128 in the form of a Requirement Completeness Index (RCI). The RCI is generated by computing a percentage weighted score for each of the individual pre-defined parameters associated with each user story data and cumulatively computing the percentage weighted score for generating the RCI. In an exemplary embodiment of the present invention, RCI is generated using a weighted score provided to each of the pre-defined parameters. A default weighted score is provided to each of the pre-defined parameters, which may be modified based on the domain related to the user story data. For example, action outcome may not be specified for technical user stories data, in that event the weighted score is ‘0’, or if the domain does not have practice of following a format for acceptance criteria, the weighted score for format of acceptance criteria may be ‘0’. Further, the pre-defined parameter based on the RCI are configurable and indicates clarity and readiness of the user story data. RCI is internally generated by the weighted score provided to each pre-defined parameter associated with the user story data that is verified. If an organization is in the early stages of requirements management maturity, it may not be satisfying all the pre-defined parameters. For example, the user stories may not have action outcome, acceptance criteria and sufficient length. In that event, a lower threshold for RCI may be selected (e.g., 60), such that sum of weightage for action, actor and action outcome is >60. Thereafter, action outcome may be included in all user stories data, so that the threshold may be above 60 after few sprints. Further, the practice of introducing acceptance criteria may be improved. Thus, the user story data is improved based on setting up a pre-defined threshold value associated with the RCI. Further, the threshold may be increased (e.g., 80), and sum of weightage for action, actor, action outcome and acceptance criteria are >80. Thus, the writing of acceptance criteria for all user stories data is improved. Further, the RCI configuration may be changed to reflect improvement in maturity of handling agile requirements.

In an embodiment of the present invention, based on the RCI, the output and correction unit 128 is configured to correct the user story data by removing identified defects and ambiguity associated with the user story data. For example, if a user story data is defined as “as an administrator I should be able to add a user and edit the profile so that I can manage user access” and the identified defect is that the user story is too long and therefore should be atomic in nature. As such, the output and correction unit 128 is configured to correct the user story data as “as an administrator I should be able to add a user so that I can add new members”. In another example, if a user story data is defined as “as a shopping user, I should be able to view the items searched in a few seconds so that I can add items to the cart” and the identified defect is that “the term ‘few’ indicates ambiguity and can be qualified better. As such, the output and correction unit 128 is configured to correct the user story data as “as a shopping user, I should be able to view the items searched within five seconds so that I can add items to the cart”.

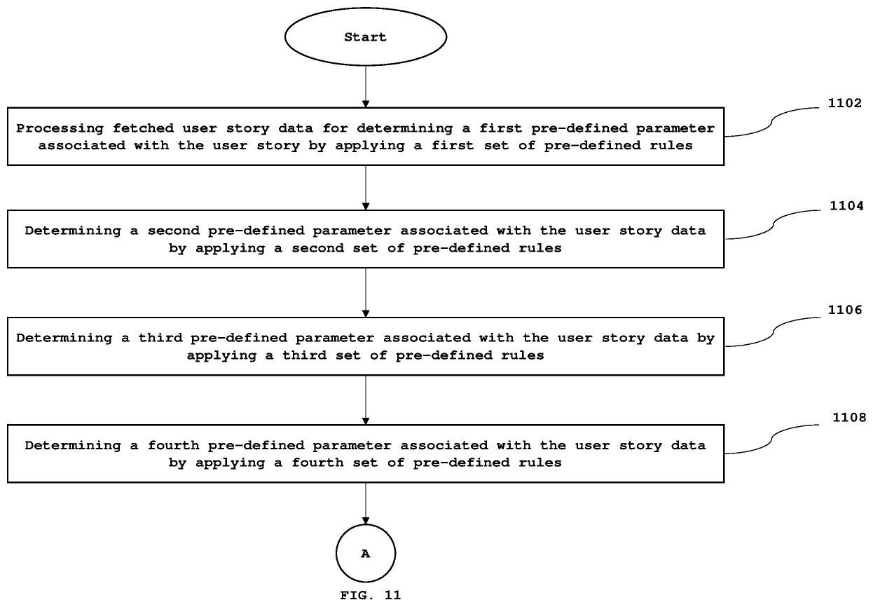

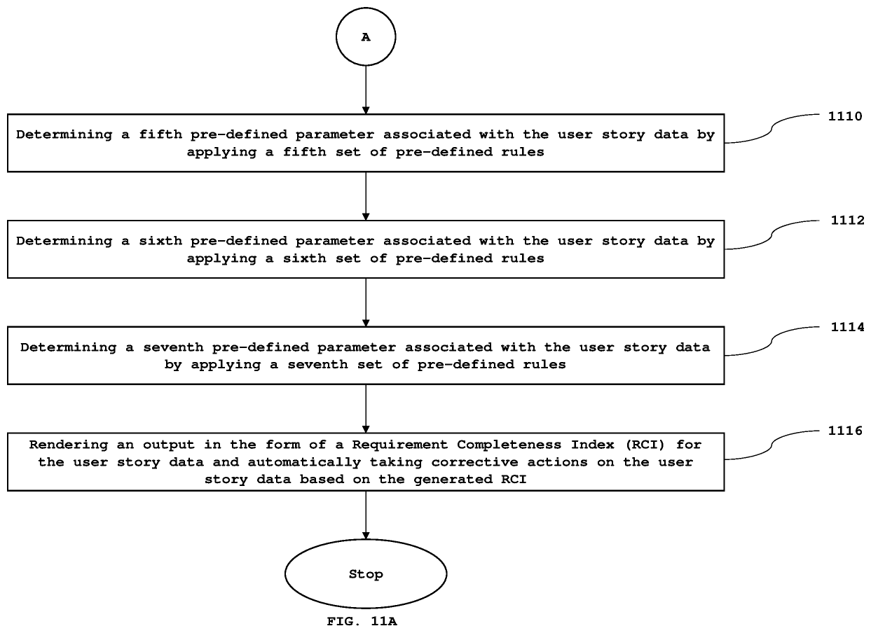

FIGS. 11 and 11A illustrate a flowchart depicting a method for optimized processing of user requirements data in a software development life cycle, in accordance with various embodiments of the present invention.

At step 1102, fetched user story data is processed for determining a first pre-defined parameter associated with the user story by applying a first set of pre-defined rules. In an embodiment of the present invention, user requirements are present in the form of user stories data at an external source system (not shown) installed at the user-end. The user story data is generally in the form of NL. User stories data aid in determining how a software development work may deliver value to the user. The user stories data are provided as primary input for creating application increments. Application increments relate to developments carried out in a specified time on an existing application. In operation, in an embodiment of the present invention, user stories data is periodically and incrementally fetched from the external source systems by using workflow management tools such as Jira®, etc.

In an embodiment of the present invention, a first pre-defined parameter associated with the user story data is determined by processing NL data present in the user story data by applying a first set of pre-defined rules. In an exemplary embodiment of the present invention, the first pre-defined parameter represents the persona of the user associated with the user story data. In an exemplary embodiment of the present invention, the user persona is determined from the user story data in two ways by applying the first set of pre-defined rules. Firstly, a user story data format used for user story creation is processed. The user story data format is processed by analyzing one or more regular expressions present in the user story to determine and validate the user persona associated with the user story data. The regular expressions are analyzed by applying a pre-built NLP library. The pre-built NLP library is built based on historical data associated with various user stories of different domains. Regular expression data present in the user story is determined as Parts of Speech (POS) (e.g., nouns, verbs, ADP (adposition), DET (determiner), etc.) and further correlation between the data present in the user story data is determined. For example, if the user story data format is described as “as a test manager I should be able to delete all defects that are stale so that defect backlog is optimized”, a regular such expression as “r′(?:\bAs\b|\.\s+?\bAs\bAs\b|\n\s?\bAs\b)\s+(\w+)\s+(\w+)(?:\s+\w+)?(?:\s+\w+)′” is used to identify the noun or proper noun, and further correlation between the data present in the user story data is determined. In another example, if user story data is described as ‘as a test manager I should be able to delete all defects that are stale so that defect backlog is optimized’, then the user persona determined is ‘test manager’. The data ‘test’ and ‘manager’ are identified as nouns, the data ‘as’ is identified as ADP and the data ‘a’ is identified as DET. Secondly, in the event, it is determined that the user story format is not determinable from the user story data, then NLP Parts-Of-Speech (POS) parsers are applied to identify POS from the user story data, such as, first proper noun that is present in the user story sentence for identifying the user persona. Further, identified user persona from the user story data is verified against a Named Entity Recognition (NER) dataset created based on the format of user story data, and if verified successfully POS is identified as user persona. For example, if the user story is described as ‘administrator should be able to configure user role-based access’ then the user persona determined is ‘administrator’, as POS tag identifies ‘administrator’ as proper noun. The identified user persona is then verified against NER dataset and is identified as a valid user persona.

At step 1104, a second pre-defined parameter associated with the user story data is determined by applying a second set of pre-defined rules. In an embodiment of the present invention, the second pre-defined parameter represents action requirement associated with the user story data for an application. The user story data is analyzed for extracting the action requirement by applying the second set of pre-defined rules. A data pattern is determined in the user story data in the event user story format is determinable for determining the second pre-defined parameter. As such, a regular expression “r′(?:\bI want \bI|\bwant\b|\bI should\b|\bwe want\b|\bwe should\b|\bI'm able to\b|\bI'm able to b|\bI am able to\b|\bI wish to\b| \bI can\b| \bI would like to\b|\bI need to\b|\bshould be able to\b|\bI could\b|\bcan able to\b|\bcould be \b|\bable to\b|\bneed\b|\bneeds\b|\bshould find\b|\bmust be \b|\bI do\b|\bto see\b)*” is applied to determine the verb following this pattern or regex pattern “r′.+(?=\bso that\b|\bso as to\b|\bIn order to\b|\bBecause of\b|\bSo\b|\bsuch that\b)′” is applied to determine the verb appearing before this pattern. For example, if the user story data is described as ‘as a test manager I should be able to delete all defects that are stale so that defect backlog is optimized’, then the first regex pattern is applied to determine the verb following this pattern or regex pattern and the action requirement determined is ‘delete all defects’. In another embodiment of the present invention, in the event user story format is not determinable, then the second pre-defined parameter is determined by firstly, determining a first POS (such as verbs) using one or more NLP POS tags (e.g., POBJ, DOBJ, XCOMP (Open Clausal Complement), etc.); secondly, determining root of the first word with POS (‘VB’ (verb), ‘VBG’ (verb gerund), ‘VBZ’ (verb, present tense with third person singular), ‘VBD’ (verb past tense)) having dependency tag XCOMP and child of the verb having a dependency tag DOBJ (Direct Object); and thirdly, if there is no root associated with XCOMP, and if child of the first word with POS (‘VB’, ‘VBG’, ‘VBZ’, ‘VBD’) is a PREP (preposition), then child of PREP is checked. In an example, if a user story data is described as ‘as a system, User Interface (UI) should be revamped’, then the action requirement is identified based on root of action word “revamped” (which is the verb identified with the POS tags) with associated POBJ (Object of Preposition) which is “system”. As such, the dependency tag between the PREP word and its child may be POBJ or DOBJ.

At step 1106, a third pre-defined parameter associated with the user story data is determined by applying a third set of pre-defined rules. In an embodiment of the present invention, the third pre-defined parameter represents an action outcome associated with the user story data for an application. The user story data is analyzed for extracting the action outcome requirement from the user story data by applying the third set of pre-defined rules. In an embodiment of the present invention, in the event user story format is determinable, then the third pre-defined parameter is determined by applying the Regex (regular expressions) data. In an exemplary embodiment of the present invention, Regex “(?:\bso that\b|\bso as to \b|\bIn order to\b|\bBecause\b|\bSo\b|\bthus\b).*′” is applied to determine the action outcome that comes after the pattern. For example, if the user story data is described as ‘as a test manager I should be able to delete all defects that are stale so that defect backlog is optimized’, then the data pattern determined in the user story relates to ‘so that’ and the action outcome determined is ‘defect backlog is optimized’. In another embodiment of the present invention, in the event user story format is not determinable, then the third pre-defined parameter is determined based on using POS tags. In this scenario, a phrase occurring in the last part of the user story data is identified by words following action. In this last part, phrase starting with ‘to’ which follows a verb (using POS tags ‘VB’, ‘VBG’, ‘VBZ’, ‘VBD’) other than ‘be’ is determined as the action outcome. For example, if the user story data is described as ‘as an admin, I should have access to all profiles to ensure that protocol is followed’, then the POS tags (‘VB’, ‘VBG’, ‘VBZ’, ‘VBD’) are used to determine the action outcome requirement associated with the user story data, which is ‘to ensure that protocol is followed’.

In an embodiment of the present invention, false positive data is minimized. POS tags specific to context of the user story data are identified. For example, the data ‘link’ may be a verb or noun depending on the context of the user story data. In an exemplary embodiment of the present invention, a data model is executed by using a Viterbi® technique in order to minimize false positive data. As such, the data model is trained with a static list of words tagged to the POS so that appropriate parts of speech can be identified based on the current context of the user story data. Appropriate parts of speech are identified based on custom training of the data model using Viterbi® technique. Viterbi® technique works on the basis of Hidden Markov Model and is optimized for better memory usage to determine the false positive data.

At step 1108, a fourth pre-defined parameter associated with the user story data is determined by applying a fourth set of pre-defined rules. In an embodiment of the present invention, the fourth pre-defined parameter represents atomicity of the user story data. Atomicity of the user story data is determined by analyzing the action identified for identifying the POS having one or more actions (‘VB’, ‘VBG’, ‘VBZ’, ‘VBD’) based on executing the fourth set of pre-defined rules. The fourth set of pre-defined rules are executed based on the POS tag of CONJ (conjunction). For example, in the event there are multiple POS identified as conjunction, then in such POS a check is carried out for determining a noun with a corresponding verb. As such, if a verb is not associated with the noun, then the user story data is determined to have atomicity. In another example, atomicity in the user story data may be identified, despite presence of a conjunction.

At step 1110, a fifth pre-defined parameter associated with the user story data is determined by applying a fifth set of pre-defined rules. In an embodiment of the present invention, the fifth pre-defined parameter represents ambiguity in the user story data. One or more categories associated with ambiguous words are determined by applying the fifth set of pre-defined rules. The categories associated with ambiguous words include, but are not limited to, comparative data, indirect data, persuasion data, qualifier data, and quantities data. The categories of ambiguous words are determined by checking for presence of ambiguous words from a pre-defined dataset of ambiguous words present in the user story data. In an example, the comparative data includes phrases comparing two or more data types, and determining object of the data being compared (e.g., bigger, smaller, wider, biggest, smallest, etc.). The indirect data include data that suggest possibility of a user requirement happening (e.g., should, could, may and will), but not specifically determining when and how the user requirement may happen. The persuasion data includes data which is obvious and based on an opinion or a fact (e.g., clearly, certainly, and obviously). The qualifier data includes data used to modify existing data for determining correct inference (e.g., all, every, none, only, never, always, sometimes, often, usually, etc.). The quantities data include data defining some amount, number, or items (e.g., a, an, some, most, few, etc.). In another embodiment of the present invention, the false positive data associated with the identified ambiguities data present in the user story data is identified for correctly determining the ambiguity data. For example, the data ‘all’ is a word indicating ambiguity and if the entity denoted by ‘all’ is qualified sufficiently, then there is no ambiguity. Further, in order to determine whether there is a qualifier data, the dependency modifier tags e.g., “relcl” (relative clause), “acl” (adnominal clause?), “advmod” (adverbial modifier), “advmod: emph” (emphasizing word of adverbial modifier) and “amod” (adjectival modifier) are used. If the dependency modifier tags are used along with the entity in the user story data, then the dependency modifier tags are not marked as ambiguous if ambiguous words are present in the user story data. Further, the dependency modifier tag is used to mark ‘all defects that are stale’ as unambiguous even though the ambiguous word “all” is present.

At step 1112, a sixth pre-defined parameter associated with the user story data is determined by applying a sixth set of pre-defined rules. In an embodiment of the present invention, the sixth pre-defined parameter represents acceptance criteria for the user story data. As such, the acceptance criteria may or may not be a part of the user story data. For example, if a user story data is defined as “as a scrum master I would like to view all past unresolved defects so that I can create a defect board”, then an acceptance criterion is “unresolved defects should be one of the following status—new, active, and deferred”, “defects with notes on dependency should be flagged for attention” and “defects should be listed in reverse chronological order along with module information”. The acceptance criteria are determined by implementing a trained acceptance criteria ML model, using the sixth set of pre-defined rules. The acceptance criteria ML model is trained and generated based on historical acceptance criteria data. In an exemplary embodiment of the present invention, the acceptance criteria ML model determines the acceptance criteria by determining if the acceptance criteria data has been added in the user story data description field. The acceptance criteria are determined by analyzing one or more suffix tags such as ‘acceptance criteria:’, ‘acc. criteria:’, etc., present in the user story data. The suffix tags are identified by one or more data input adaptors associated with the acceptance criterion ML model. The identified suffix data is thereafter stored in a separate data field. In another embodiment of the present invention, one or more data adaptors are created for the specific Application Life Management (ALM) tool using the relevant APIs to retrieve user story data. Once the user story data is retrieved in the data adaptor, it checks for data related to acceptance criteria based on the default list of tags used to identify acceptance criteria. The data adaptor further determines a parameter if the tags are not one of the tags available in the pre-defined tags. The parameter is then stored and used for subsequent incremental data processing. Further, the acceptance criteria are determined by the acceptance criteria ML model based on associated historical data of user story data and corresponding acceptance criteria by carrying out pattern mining to identify the association amongst user story data. For example, if a user story data is described as, ‘add a user’, then the acceptance criteria associated with the said user story data may be determined as ‘add user in bulk’, ‘add one user at a time’ or ‘what type of user needs to be added’.

In an embodiment of the present invention, the acceptance criteria may be determined by the acceptance criteria ML model for new user stories data by carrying out nested clustering of user stories data and acceptance criteria associated with the historical user story data. In an exemplary embodiment of the present invention, a custom iGraph clustering technique is implemented to carry out clustering of user stories data and acceptance criteria associated with the historical user story data. Further, based on the clustering technique, repeatable acceptance criteria appearing under different, but similar, user stories data are identified. The user stories data are created as a pattern and stored. In the event a new user story is processed, it is validated for similarity with the stored pattern and the corresponding acceptance criteria is recommended.

At step 1114, a seventh pre-defined parameter associated with the user story data is determined by applying a seventh set of pre-defined rules. In an embodiment of the present invention, the seventh pre-defined parameter represents determination of length of the user story data. In an embodiment of the present invention, it is verified whether the length of the user story data is greater than a pre-defined user story data configurable length or not. In an exemplary embodiment of the present invention, the count of words in the user story data before eliminating the stop words is computed as length of the user story data. Determination of length of the user story data determines if sufficient data is provided in the user story data. The user stories data having data less than the pre-defined user story data configurable length is flagged. For example, user story data defined as ‘software upgrade’ is flagged as having data less than the pre-defined user story data configurable length. In another embodiment of the present invention, it is determined that each user story data is unique based on verification of the title or summary of the user story data. The title or summary of the user story data is verified to be unique based on comparison with the other user stories delivered in the current or past sprints. The comparison is done by carrying out a string match between the titles of user stories data.

At step 1116, an output is rendered in the form of a Requirement Completeness Index (RCI) for the user story data and corrective actions are automatically carried out on the user story data based on the generated RCI. In an embodiment of the present invention, the RCI is generated by computing a percentage weighted score for each of the individual pre-defined parameters associated with each user story data and cumulatively computing the percentage weighted score for generating the RCI. In an exemplary embodiment of the present invention, RCI is generated using a weighted score provided to each of the pre-defined parameters. A default weighted score is provided to each of the pre-defined parameters, which may be modified based on the domain related to the user story data. For example, action outcome may not be specified for technical user stories data, in that event the weighted score is ‘0’, or if the domain does not have practice of following a format for acceptance criteria, the weighted score for format of acceptance criteria may be ‘0’. Further, the pre-defined parameter based on the RCI are configurable and indicates the clarity and readiness of the user story data. RCI is internally generated by the weighted score provided to each pre-defined parameter associated with the user story data that is verified. If an organization is in the early stages of requirements management maturity, it may not be satisfying all the pre-defined parameters. For example, the user stories may not have action outcome, acceptance criteria and sufficient length. In that event, a lower threshold for RCI may be selected (e.g., 60), such that sum of weightage for action, actor and action outcome is >60. Thereafter, action outcome may be included in all user stories data, so that the threshold may be above 60 after few sprints. Further, the practice of introducing acceptance criteria may be improved. Thus, the user story data is improved based on setting up a pre-defined threshold value associated with the RCI. Further, the threshold may be increased (e.g., 80), and sum of weightage for action, actor, action outcome and acceptance criteria are >80. Thus, the writing of acceptance criteria for all user stories data is improved. Further, the RCI configuration may be changed to reflect improvement in maturity of handling agile requirements.

In an embodiment of the present invention, based on the RCI, the user story data is corrected by removing identified defects and ambiguity associated with the user story data. For example, if a user story data is defined as “as an administrator I should be able to add a user and edit the profile so that I can manage user access” and the identified defect is that the user story is too long and therefore should be atomic in nature. As such, the user story data is corrected as “as an administrator I should be able to add a user so that I can add new members”. In another example, if a user story data is defined as “as a shopping user, I should be able to view the items searched in a few seconds so that I can add items to the cart” and the identified defect is that “the term ‘few’ indicates ambiguity and can be qualified better. As such, the user story data is corrected as “as a shopping user, I should be able to view the items searched within five seconds so that I can add items to the cart”.

Advantageously, in accordance with various embodiments of the present invention, the present invention provides for optimized processing of user requirements data in a software development life cycle in an efficient manner by removing any human intervention relating to peer-to-peer review. The requirements data is analyzed in an automated manner thereby avoiding assumptions which may lead to defects in User Acceptance Testing (UAT) and thereafter corrected before development stage. The present invention provides for consistently maintaining quality of user story data. The present invention provides for preventing requirement phase related defects and deficiencies to be passed on to development and testing stage. Further, the present invention provides for timely delivery of developed applications without any schedule slippages and in a cost-effective manner based on appropriate determination of defects and ambiguities associated with the user requirements. Furthermore, the present invention provides for efficient maintenance of data for knowledge transfer process associated with the application by preventing loss of data associated with user requirements.

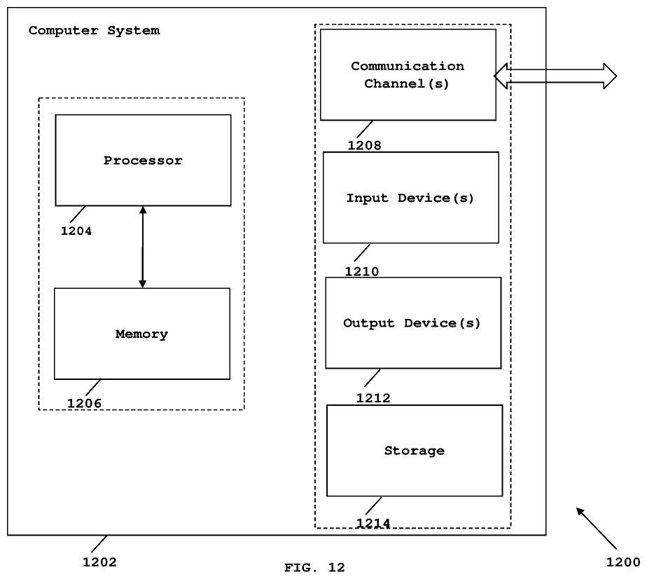

FIG. 12 illustrates an exemplary computer system in which various embodiments of the present invention may be implemented. The computer system 1202 comprises a processor 1204 and a memory 1206. The processor 1204 executes program instructions and is a real processor. The computer system 1202 is not intended to suggest any limitation as to scope of use or functionality of described embodiments. For example, the computer system 1202 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 1206 may store software for implementing various embodiments of the present invention. The computer system 1202 may have additional components. For example, the computer system 1202 includes one or more communication channels 1208, one or more input devices 1210, one or more output devices 1212, and storage 1214. An interconnection mechanism (not shown) such as a bus, controller, or network, interconnects the components of the computer system 1202. In various embodiments of the present invention, operating system software (not shown) provides an operating environment for various software executing in the computer system 1202 and manages different functionalities of the components of the computer system 1202.

The communication channel (s) 1208 allows communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth, or other transmission media.

The input device (s) 1210 may include, but not limited to, a keyboard, mouse, pen, joystick, trackball, a voice device, a scanning device, touch screen or any another device that is capable of providing input to the computer system 1202. In an embodiment of the present invention, the input device (s) 1210 may be a sound card or similar device that accepts audio input in analog or digital form. The output device (s) 1212 may include, but not limited to, a user interface on CRT or LCD, printer, speaker, CD/DVD writer, or any other device that provides output from the computer system 1202.

The storage 1214 may include, but not limited to, magnetic disks, magnetic tapes, CD-ROMs, CD-RWs, DVDs, flash drives or any other medium which can be used to store information and can be accessed by the computer system 1202. In various embodiments of the present invention, the storage 1214 contains for implementing the described embodiments.

The present invention may suitably be embodied as a computer program product for use with the computer system 1202. The method described herein is typically implemented as a computer program product, comprising a set of program instructions which are executed by the computer system 1202 or any other similar device. The set of program instructions may be a series of computer readable codes stored on a tangible medium, such as a computer readable storage medium (storage 1214), for example, diskette, CD-ROM, ROM, flash drives or hard disk, or transmittable to the computer system 1202, via a modem or other interface device, over either a tangible medium, including but not limited to optical or analogue communications channel (s) 1208. The implementation of the invention as a computer program product may be in an intangible form using wireless techniques, including but not limited to microwave, infrared, Bluetooth, or other transmission techniques. These instructions can be preloaded into a system or recorded on a storage medium such as a CD-ROM or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer r network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for optimized processing of requirements data in a software development life cycle, the system comprising:
a memory storing program instructions;
a processor executing instructions stored in the memory;
a requirements analysis engine executed by the processor and configured to:
process fetched user story data from a database for determining a first pre-defined parameter associated with the user story by applying a first set of pre-defined rules, wherein the first pre-defined parameter represents persona of the user associated with the user story data;
determine a second pre-defined parameter associated with the user story data by applying a second set of pre-defined rules, wherein the second pre-defined parameter represents action requirement associated with the user story data for an application;
determine a third pre-defined parameter associated with the user story data by applying a third set of pre-defined rules, wherein the third pre-defined parameter represents action outcome associated with the user story data for the application;
determine a fourth pre-defined parameter associated with the user story data by applying a fourth set of pre-defined rules, wherein the fourth pre-defined parameter represents atomicity of the user story data;
determine a fifth pre-defined parameter associated with the user story data by applying a fifth set of pre-defined rules, wherein the fifth pre-defined parameter represents ambiguity in the user story data;
determine a sixth pre-defined parameter associated with the user story data by applying a sixth set of pre-defined rules, wherein the sixth pre-defined parameter represents acceptance criteria for the user story data; and
determine a seventh pre-defined parameter associated with the user story data by applying a seventh set of pre-defined rules, wherein the seventh pre-defined parameter represents determination of length of the user story data;
and
an output and correction unit configured to render an output in the form of a Requirement Completeness Index (RCI) for the user story data, the RCI is generated based on a cumulative computation of percentage weighted score for each of the pre-defined parameters, and corrective actions are automatically carried out on the user story data based on the generated RCI.

2. The system as claimed in claim 1, wherein the requirements analysis engine comprises a story fetching unit executed by the processor and configured to periodically and incrementally fetch user stories data from external source systems by employing workflow management tools, and wherein the fetched user stories data are stored in the database for later retrieval.

3. The system as claimed in claim 1, wherein the requirements analysis engine comprises a persona identification unit executed by the processor and configured to determine user persona from the user story data by applying the first set of pre-defined rules including processing a user story data format used for user story creation by analyzing one or more regular expressions present in the user story to determine and validate the user persona associated with the user story data, and wherein the one or more regular expressions are analyzed by applying a pre-built NLP library, the regular expression data present in the user story are determined as Parts of Speech (POS), and wherein a correlation is determined between the data present in the user story data.

4. The system as claimed in claim 3, wherein the user persona is determined from the user story data by applying the first set of pre-defined rules including in the event it is determined by the persona identification unit that the user story format is not determinable from the user story data, then NLP Parts-Of-Speech (POS) parsers are applied by the persona identification unit to identify POS that is present in the user story sentence from the user story data for identifying the user persona, and wherein the identified user persona from the user story data is verified against a Named Entity Recognition (NER) dataset created based on the format of user story data, and if verified successfully the POS is s identified as user persona.

5. The system as claimed in claim 1, wherein the requirements analysis engine comprises an action identification unit executed by the processor and configured to analyze the user story data for extracting the action requirement by applying the second set of pre-defined rules, and wherein a data pattern is determined in the user story data in the event user story format is determinable for determining the second pre-defined parameter.

6. The system as claimed in claim 5, wherein the action identification unit is configured to determine the second pre-defined parameter, in the event user story format is not determinable, by firstly determining a first POS using one or more NLP POS tags; by secondly determining root of the first word with POS (‘VB’ (verb), ‘VBG’ (verb gerund), ‘VBZ’ (verb, present tense with third person singular), ‘VBD’ (verb past tense)) having dependency tag XCOMP and child of the verb having a dependency tag DOBJ; and thirdly by checking child of PREP if there is no root associated with XCOMP, and if child of the first word with POS (‘VB’, ‘VBG’, ‘VBZ’, ‘VBD’) is a PREP (preposition).

7. The system as claimed in claim 1, wherein the requirements analysis engine comprises an action outcome identification unit executed by the processor and configured to analyze the user story data for extracting the action outcome requirement from the user story data by applying the third set of pre-defined rules, and wherein in the event user story format is determinable, then the action outcome identification unit is configured to determine the third pre-defined parameter by applying a Regex (regular expressions) data, and wherein in the event user story format is not determinable, then the action outcome identification unit is configured to determine the third pre-defined parameter by using POS tags and a phrase occurring in the last part of the user story data is identified by words following action.

8. The system as claimed in claim 5, wherein the action identification unit is configured to minimize false positive data by execute a data model by using a Viterbi® technique, and wherein the data model is trained with a static list of words tagged to the POS for identifying appropriate parts of speech based on the current context of the user story data.

9. The system as claimed in claim 1, wherein the requirements analysis engine comprises an atomicity identification unit executed by the processor and configured to determine atomicity of the user story data by analyzing the action identified by an action identification unit for identifying the POS having one or more actions (‘VB’, ‘VBG’, ‘VBZ’, ‘VBD’) based on executing the fourth set of pre-defined rules, and wherein the fourth set of pre-defined rules are executed based on the POS tag of CONJ (conjunction), and wherein atomicity in the user story data is identified by the atomicity identification unit, despite presence of a conjunction.

10. The system as claimed in claim 1, wherein the requirements analysis engine comprises an ambiguity identification unit executed by the processor and configured to determine one or more categories associated with the ambiguous words by applying the fifth set of pre-defined rules, and wherein the categories associated with ambiguous words comprises comparative data, indirect data, persuasion data, qualifier data, and quantities data, and wherein the categories of ambiguous words are determined by checking for the presence of ambiguous words from a pre-defined dataset of ambiguous words present in the user story data.

11. The system as claimed in claim 10, wherein the ambiguity identification unit is configured to identify the false positive data associated with the identified ambiguities data present in the user story data for correctly determining the ambiguity data.

12. The system as claimed in claim 1, wherein the requirements analysis engine comprises an acceptance criteria verification unit executed by the processor and configured to determine the acceptance criteria by implementing a trained acceptance criteria Machine Learning (ML) model stored in the database, using the sixth set of pre-defined rules, and wherein the acceptance criteria ML model is trained and generated based on historical acceptance criteria data, and wherein the acceptance criteria ML model determines the acceptance criteria by determining if the acceptance criteria data has been added in the user story data description field, and wherein the acceptance criteria is determined by analyzing one or more suffix tags present in the user story data, the suffix tags are identified by one or more data input adaptors associated with the acceptance criterion ML model.

13. The system as claimed in claim 12, wherein one or more data adaptors are created for a specific Application Life Management (ALM) using tool relevant Application Programming Interfaces (APIs) to retrieve user story data for checking data related to acceptance criteria based on the default list of tags used to identify acceptance criteria.

14. The system as claimed in claim 12, wherein the acceptance criteria is determined by the acceptance criteria ML model based on associated historical data of user story data and corresponding acceptance criteria by carrying out pattern mining to identify the association amongst user story data.

15. The system as claimed in claim 12, wherein the acceptance criteria is determined by the acceptance criteria ML model for new user stories data by carrying out nested clustering of user stories data and acceptance criteria associated with the historical user story data, and wherein an iGraph clustering technique is implemented by the acceptance criteria verification unit to carry out clustering of user stories data and acceptance criteria associated with the historical user story data, and wherein based on the clustering technique repeatable acceptance criteria appearing under different but similar user stories data are identified.

16. The system as claimed in claim 15, wherein the user stories data is created as a pattern and stored in the database, and wherein when a new user story is processed, it is validated for similarity with the stored pattern and the corresponding acceptance criteria is recommended by the acceptance criteria verification unit.

17. The system as claimed in claim 1, wherein the requirements analysis engine comprises a sufficiency checking unit executed by the processor and configured to verify whether length of the user story data is greater than a pre-defined user story data configurable length or not, and wherein the count of words in the user story data before eliminating the stop words is computed as length of the user story data, and wherein the sufficiency checking unit is configured to flag the user stories data having data less than the pre-defined user story data configurable length.

18. The system as claimed in claim 17, wherein the sufficiency checking unit is configured to determine that each user story data is unique based on verification of the title or summary of the user story data, and wherein the title or summary of the user story data is verified to be unique based on comparison with the other user stories delivered in the current or past sprints, and wherein the comparison is done by carrying out a string match between the titles of user stories data by the sufficiency checking unit.

19. The system as claimed in claim 1, wherein an output is rendered at the user-end via an output and correction unit in the form of the Requirement Completeness Index (RCI), and wherein the pre-defined parameter based on RCI are configurable and indicates clarity and readiness of the user story data, and wherein the user story data is improved by setting up a pre-defined threshold value associated with the RCI.

20. A method for optimized processing of requirements data in a software development life cycle, the method is implemented by a processor executing instructions stored in a memory, the method comprises:
processing fetched user story data from a database for determining a first pre-defined parameter associated with the user story by applying a first set of pre-defined rules, wherein the first pre-defined parameter represents persona of the user associated with the user story data;
determining a second pre-defined parameter associated with the user story data by applying a second set of pre-defined rules, wherein the second pre-defined parameter represents action requirement associated with the user story data for an application;
determining a third pre-defined parameter associated with the user story data by applying a third set of pre-defined rules, wherein the third pre-defined parameter represents action outcome associated with the user story data for the application;
determining a fourth pre-defined parameter associated with the user story data by applying a fourth set of pre-defined rules, wherein the fourth pre-defined parameter represents atomicity of the user story data;
determining a fifth pre-defined parameter associated with the user story data by applying a fifth set of pre-defined rules, wherein the fifth pre-defined parameter represents ambiguity in the user story data;
determining a sixth pre-defined parameter associated with the user story data by applying a sixth set of pre-defined rules, wherein the sixth pre-defined parameter represents acceptance criteria for the user story data;
determining a seventh pre-defined parameter associated with the user story data by applying a seventh set of pre-defined rules, wherein the seventh pre-defined parameter represents determination of length of the user story data; and
rendering an output in the form of a Requirement Completeness Index (RCI) for the user story data, the RCI is generated based on a cumulative computation of percentage weighted score for each of the pre-defined parameters, and corrective actions are automatically carried out on the user story data based on the generated RCI.

21. The method as claimed in claim 20, wherein user persona is determined from the user story data by applying the first set of pre-defined rules by processing a user story data format used for user story creation by analyzing one or more regular expressions present in the user story to determine and validate the user persona associated with the user story data, and wherein the one or more regular expressions are analyzed by applying a pre-built NLP library, the regular expression data present in the user story are determined as Part of Speech (POS), and wherein a correlation is determined between the data present in the user story data.

22. The method as claimed in claim 21, wherein the user persona is determined from the user story data by applying the first set of pre-defined rules including in the event it is determined that the user story format is not determinable from the user story data, then NLP Parts-Of-Speech (POS) parsers are applied to identify POS that is present in the user story sentence from the user story data for identifying the user persona, and wherein identified user persona from the user story data is verified against a Named Entity Recognition (NER) dataset created based on the format of user story data, and if verified successfully the POS is identified as user persona.

23. The method as claimed in claim 20, wherein a data pattern is determined in the user story data in the event user story format is determinable for determining the second pre-defined parameter.

24. The method as claimed in claim 23, wherein in the event user story format is not determinable, then the second pre-defined parameter is determined by determining a first POS using one or more NLP POS tags; by determining root of the first word with POS (‘VB’ (verb), ‘VBG’ (verb gerund), ‘VBZ’ (verb, present tense with third person singular), ‘VBD’ (verb past tense)) having dependency tag XCOMP and child of the verb having a dependency tag DOBJ; and checking child of PREP if there is no root associated with XCOMP, and if child of the first word POS with (‘VB’, ‘VBG’, ‘VBZ’, ‘VBD’) is a PREP (preposition).

25. The method as claimed in claim 20, wherein the user story data is analyzed for extracting the action outcome requirement from the user story data by applying the third set of pre-defined rules, and wherein in the event user story format is determinable, then the third pre-defined parameter is determined by applying a Regex (regular expressions) data, and wherein in the event user story format is not determinable, then the third pre-defined parameter is determined based on using POS tags and in this scenario, a phrase occurring in the last part of the user story data is identified by words following action.

26. The method as claimed in claim 20, wherein false positive data is minimized by executing a data model by employing a Viterbi® technique, and wherein the data model is trained with a static list of words tagged to the POS for identifying appropriate parts of speech based on the current context of the user story data.

27. The method as claimed in claim 20, wherein atomicity of the user story data is determined by analyzing the action identified for identifying the POS having one or more actions (‘VB’, ‘VBG’, ‘VBZ’, ‘VBD’) by executing the fourth set of pre-defined rules, and wherein the fourth set of pre-defined rules are executed based on the POS tag of CONJ (conjunction), and wherein atomicity in the user story data is identified despite presence of a conjunction.

28. The method as claimed in claim 20, wherein one or more categories associated with the ambiguous words are determined by applying the fifth set of pre-defined rules, and wherein the categories associated with ambiguous words comprises comparative data, indirect data, persuasion data, qualifier data, and quantities data, and wherein the categories of ambiguous words are determined by checking for the presence of ambiguous words from a pre-defined dataset of ambiguous words present in the user story data.

29. The method as claimed in claim 20, wherein the acceptance criteria is determined by implementing a trained acceptance criteria Machine Learning (ML) model, using the sixth set of pre-defined rules, and wherein the acceptance criteria ML model is trained and generated based on historical acceptance criteria data, and wherein the acceptance criteria ML model determines the acceptance criteria by determining if the acceptance criteria data has been added in the user story data description field, and wherein the acceptance criteria is determined by analyzing one or more suffix tags present in the user story data, the suffix tags are identified by one or more data input adaptors associated with the acceptance criterion ML model.

30. The method as claimed in claim 29, wherein the user stories data is created as a pattern, and wherein when a new user story is processed, it is validated for similarity with the stored pattern and the corresponding acceptance criteria is recommended.

31. The method as claimed in claim 20, wherein an output is rendered in the form of the Requirement Completeness Index (RCI), and wherein the pre-defined parameter based on RCI are configurable and indicates clarity and readiness of the user story data, and wherein the user story data is improved based on setting up a pre-defined threshold value associated with the RCI.

32. A computer program product comprising:
a non-transitory computer-readable medium having computer program code stored thereon, the computer-readable program code comprising instructions that, when executed by a processor, causes the processor to:
process fetched user story data for determining a first pre-defined parameter associated with the user story by applying a first set of pre-defined rules, wherein the first pre-defined parameter represents persona of the user associated with the user story data;
determine a second pre-defined parameter associated with the user story data by applying a second set of pre-defined rules, wherein the second pre-defined parameter represents action requirement associated with the user story data for an application;
determine a third pre-defined parameter associated with the user story data by applying a third set of pre-defined rules, wherein the third pre-defined parameter represents action outcome associated with the user story data for the application;
determine a fourth pre-defined parameter associated with the user story data by applying a fourth set of pre-defined rules, wherein the fourth pre-defined parameter represents atomicity of the user story data;
determine a fifth pre-defined parameter associated with the user story data by applying a fifth set of pre-defined rules, wherein the fifth pre-defined parameter represents ambiguity in the user story data;
determine a sixth pre-defined parameter associated with the user story data by applying a sixth set of pre-defined rules, wherein the sixth pre-defined parameter represents acceptance criteria for the user story data;
determine a seventh pre-defined parameter associated with the user story data by applying a seventh set of pre-defined rules, wherein the seventh pre-defined parameter represents determination of length of the user story data; and
render an output in the form of a Requirement Completeness Index (RCI) for the user story data, the RCI is generated based on a cumulative computation of percentage weighted score for each of the pre-defined parameters, and corrective actions are automatically carried out on the user story data based on the generated RCI.
